(19) United States
(12) Patent Application Publication
(10) Pub. No.: US 2017/0275069 A1
(43) Pub. Date: Sep. 28, 2017

(54) Packaging Apparatus and Methods for Fabricating Same

(71) Applicant: Kevin Wells, Cambridge (CA)

(72) Inventor: Kevin Wells, Cambridge (CA)

(21) Appl. No.: 15/503,632

(22) PCT Filed: Aug. 11, 2015
(86) PCT No.: PCT/CA2015/050754

§ 371 Date: Feb. 13, 2017

Related U.S. Application Data
(60) Provisional application No. 62/035,741, filed on Aug. 11, 2014.

(51) Int. Cl. B65D 65/40; B65D 25/04; B26F 1/40; B65D 8/00

(52) U.S. Cl. CPC B65D 65/403; B65D 15/22; B65D 25/04; B26F 1/40; B31B 17/00; B31B 2217/103

(57) ABSTRACT

According to one aspect, an improved packaging apparatus having first panels oriented in a first direction and second panels oriented in a second direction. The first and second panels cooperate to define a plurality of cells into which parts can be received. At least some of the first and second panels are made from reclaimed waste material. The waste material could be a foam board, such as is used in the manufacturing of headliners for automotive vehicles.

### RELATED APPLICATIONS

This application claims the benefit of U.S. Provisional Patent Application Ser. No. 62/035,742, filed Aug. 11, 2014, the entire contents of which are hereby incorporated by reference herein for all purposes.

### TECHNICAL FIELD

The embodiments herein relate to packaging apparatus, and in particular to improved packaging apparatus and methods of fabricating packaging apparatus incorporating improved structural panels, such as structural panels reclaimed from waste material.

### INTRODUCTION

Generally speaking, the term “dunnage” refers to packaging materials that are used to pack, support, and protect cargo during transportation. For example, in the automotive industry, manufacturers often ship their parts in dunnage trays, with each part located within a “cell” within each tray. These trays allow parts to be transported in a relatively safe manner that helps protect their structural integrity, in some instances particularly with regards to surface finishes (i.e., class A surfaces, for example).

Many current dunnage trays incorporate extruded polymer panels (i.e., corrugated plastic panels) that are cut, scored and in some cases folded to form the cells of the tray.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is an image of a conventional dunnage tray formed of extruded corrugated plastic panels that have been covered with a fabric material;

FIG. 1A is a close up perspective view of another dunnage tray formed of extruded corrugated plastic panels shown without being covered by a fabric material;

FIG. 2 is a close-up image of an edge of an extruded corrugated plastic panel;

FIG. 3 is an end-view of a corrugated plastic panel illustrating two possible cutting locations;

FIG. 4 is a close-up image of a conventional dunnage tray showing a poor fit for the part received therein;

FIG. 5 is an image of a packaging apparatus formed using improved structural panels according to one embodiment;

FIG. 6 is a cross-sectional schematic view of a headliner material for use in a structural panel according to some embodiments;

FIG. 7 is a cross-sectional schematic view of another headliner material for use in a structural panel according to some other embodiments;

FIG. 8 is a photo of a packaging apparatus formed using improved structural panels according to some embodiments in which edges of the panels have been covered with a fabric using stitching; and

FIG. 9 is a schematic of a method of fabricating a packaging apparatus.

### DETAILED DESCRIPTION OF SOME EMBODIMENTS

It will be appreciated that for simplicity and clarity of illustration, where appropriate, reference numerals may be repeated among the figures to indicate corresponding or analogous elements. In addition, numerous specific details are set forth in order to provide a thorough understanding of the example embodiments described. However, in some instances, well-known methods, procedures and components may not have been described in detail so as not to obscure some embodiments as described herein.

Although conventional dunnage trays are widely used, and are useful in many applications, they often do not provide desired levels of performance. More particularly, some conventional dunnage trays have deficiencies in one or more areas, such as having inadequate strength or non-homogeneous strength (i.e., the strength of various portions of the packaging may not be uniform in all directions).

Some conventional dunnage trays suffer from a general inability to achieve certain shapes when cutting or scoring based on the nature of the panels used in forming the trays. For example, due to the nature of some structural panels, particularly corrugated panels, it is often difficult to achieve rounded corners, or other curved features.

Other issues with conventional dunnage may relate to productivity loses and increased scrap costs. For example, due to the non-homogeneous orientation of corrugated plastic panels, when panels are cut they may have regions of weakness, and/or may suffer from poor tolerances. This can result in panels being incorrectly sized for a particular tray, distorting cell size and shape, and in some cases resulting in waste and increased production times.

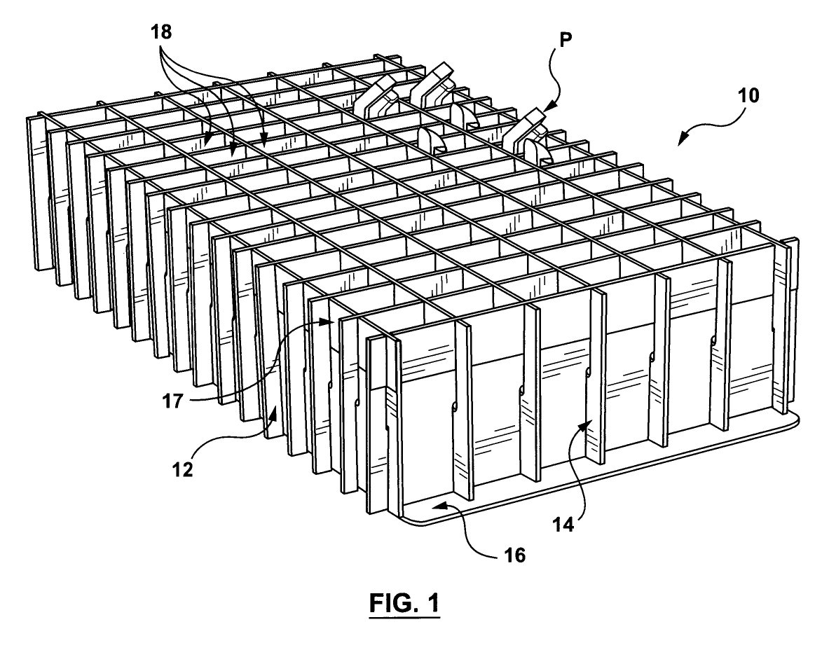

Referring now specifically to FIG. 1, illustrated therein is a conventional dunnage tray 10 according to one example. As shown, the tray 10 includes a plurality of interlocking upstanding structural panels, including first panels 12 oriented in a first direction, and second panels 14 oriented in a second direction (which in this example is perpendicular to the first direction), and which interlock with first panels 12. In this example the panels 12, 14 are supported by a base panel 16, which may be made of the same material.

Generally the panels 12, 14, 16 cooperate to define a plurality of cells 18 into which parts P can be received for transport and/or storage. For example, the parts P may be automotive parts or other parts of various shapes and sizes. The size and shape of the cells 18 can be selected to accommodate the size and shape of different parts P.

In this example, the panels 12, 14, 16 have been formed of a corrugated plastic that is covered with a fabric material 17. The fabric material 17 can be laminated onto the corrugated plastic, and may help protect the surfaces of the parts P received within the cells 18, inhibiting scratching and so on.

FIG. 1A shows another dunnage tray 10a formed of extruded corrugated plastic panels 12a, 14a that have not been covered by a fabric material, showing more clearly the interior fluted structure of the panels.

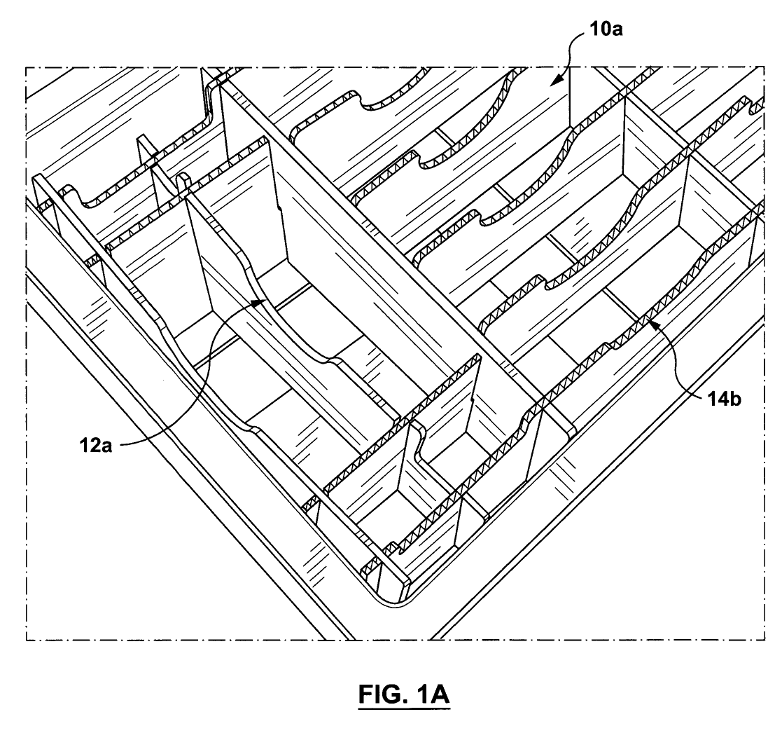

Turning now to FIG. 2, illustrated therein is close-up view of an edge of an extruded corrugated plastic panel 20, such as may be used as a panel 12, 14 or 16 in the dunnage tray 10. As shown, the panel 20 includes opposing walls 22, 24 that are spaced apart by an interior fluted structure 26 so as to provide thickness and rigidity to the panel 20. However, the size and shape of the fluted structure 26 results in gaps 27 or openings being formed in between the walls 22, 24.

These gaps 27 can be problematic. In particular, when the panel 20 is cut to a particular length, the gaps 27 may create areas of weakness. For example, as shown this panel 20 has been cut along a score line S, which generally passes through a particular gap 27a. Cutting the panel 20 through the gap 27a may result in a weakened region of the panel 20 near the score line S, since the fluted structure 26 does not directly support both opposing walls 22, 24 of the panel 20 in this region.

Furthermore, the gaps 27 may cause issues with the corner 28 of the panel 20, and in particular might result in a sharp edge and/or a flap portion 29 being formed during cutting. This is undesirable, as it could cause scratches or other damage to a surface of a part P as the part P is inserted into (or removed from) the tray.

Furthermore, the presence of the gaps 27 may make it difficult to form other features, such as a rounded or filleted corner 28, due to the lack of adequate fluted support structure 26 at the corner 28. The ability to use rounded or filleted corners (or bevelled corners) may be desirable in that it may help inhibit scratching or other damage to parts as they are inserted into and removed from the cells.

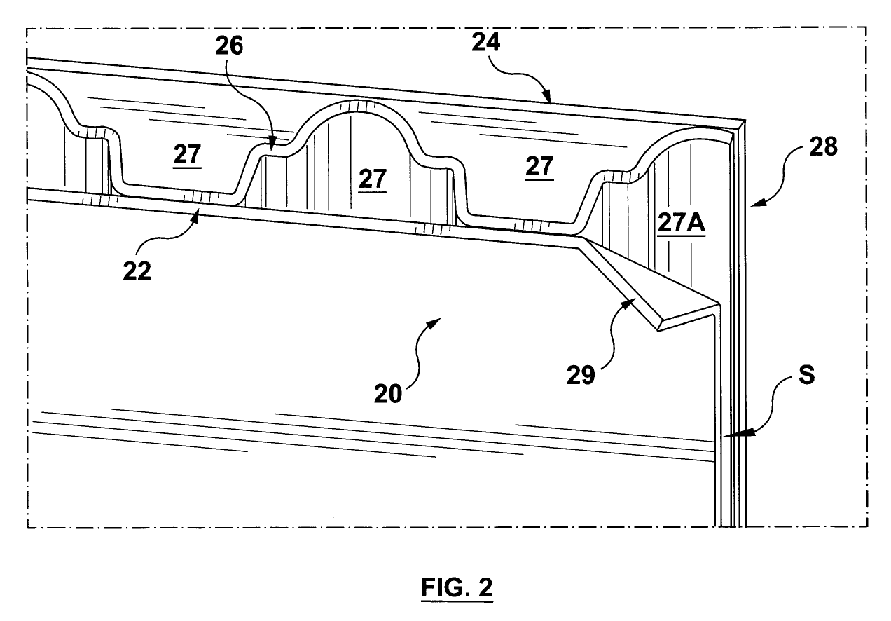

Turning now to FIG. 3, illustrated therein is an end-view of a corrugated plastic panel 30 according to another example. The panel 30 includes two opposing walls 32, 34 that are connected together and spaced apart by generally perpendicular flutes (e.g., flutes 36, 37, 38). Similar to the panel 20, the flutes 36, 37, 38 of the panel 30 define gaps therebetween. FIG. 3 also shows two of the possible locations for cutting the panel 30, identified generally as location A and location B.

As explained further below, corrugated plastic panels may suffer from tolerance issues due to the presence of the flutes and gaps and the manner in which the panels are cut. More particularly, when scoring or cutting corrugated plastic, the scoring tool will occasionally line up directly above one of these flutes 36, 37, 38 on the panel. When that happens, the flutes 36, 37, 38 of the panel 30 will tend to resist cutting, due to the pressures involved as the tool tries to push downwardly directly through the flutes. As a result, the panel 30 (or the tool, or both) will tend to shift to one side or the other of the flute in order for the cut to be completed.

For instance, when the cutting tool is located at location A, the cutting tool (i.e., a scoring die or cutting die) will tend to apply cutting pressure at a location that overlies a gap and is in between two flutes 36, 37. This generally allows the panel 30 to be cut with relatively good accuracy (although as discussed above issues can arise with respect to edge weakness and other problems).

However, when the cutting tool is located at location B, the cutting tool will be applying cutting pressure directly in alignment with the flute 38, which resists the cutting action. This resistance can cause the panel 30 to move slightly to one side or the other as the cutting tool seeks a path of “lesser resistance” in trying to cut the panel 30. This can result in poor cutting tolerances.

In some cases, it is possible that the top and bottom walls 32, 34 of the panel 30 could shift (or shear) in opposite directions. This could result in the cutting tool being misaligned by approximately +/− the thickness of the panel 30 (or more). For example, in some cases the panel 30 may be 4-5mm thick, and the cutting tool could be misaligned by 8-10mm (or more) when a cut is actually made.

This misalignment can result in the panel 30 having an undesired length, which can cause problems when assembling the panel 30 into a tray. For instance, panels that are incorrectly sized (i.e. too long or too short) may cause distortions in the size and shape of the cells within a tray.

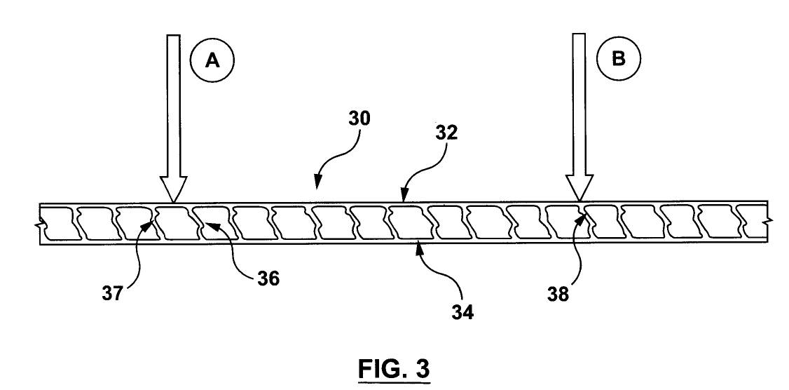

An exemplary distortion is illustrated in FIG. 4, where panels 40, 42, 44 are incorrectly sized have been assembled. As a result, the panels 40, 42 have distortions (e.g., bowing) which changes the size and shape of the cell 43. The “bowing” is also apparent on panel 44.

If this bowing or distortion causes a cell 43 to be too small, the part P may not fit within the cell 43, or may only be inserted into the cell 43 by applying excessive pressure to squeeze the part P into the cell 43. This might cause damage to the part P (particularly to the surface finish of the part P).

Conversely, if this bowing or distortion causes a cell 43 to be too large, the cell 43 may be too loose to securely hold the part P therein. This may allow the part P to move excessively during transport, which can cause also cause damage to the part P.

If an operator observes distortion in the cells, such as due to an improperly sized panel, the operator may decide to discard the incorrectly sized panel. This can cause excess waste, and may result in production delays as an appropriately sized panel is located.

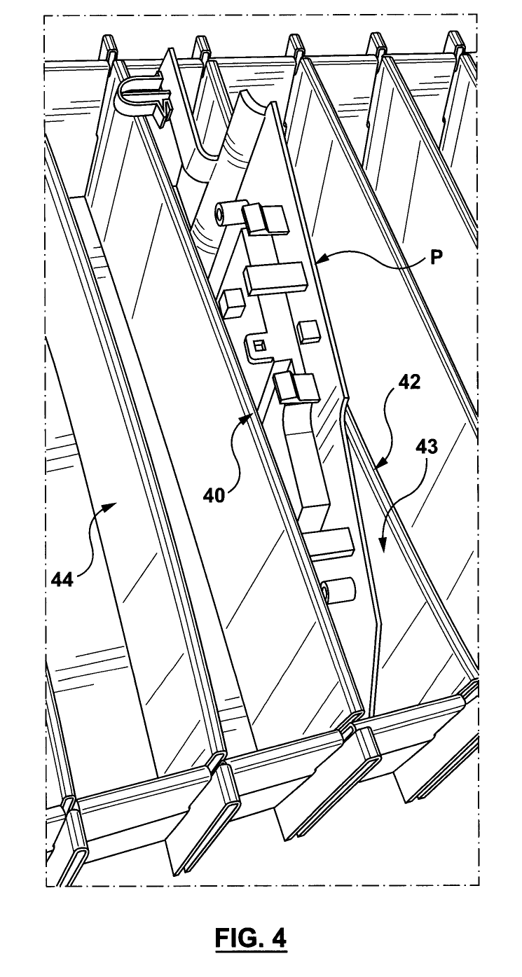

Referring now to FIG. 5, illustrated therein is a packaging apparatus 50 formed using improved structural panels according to one embodiment. The packaging apparatus 50 includes a plurality of structural panels, including first panels 52 oriented in a first direction and second panels 54 oriented in a second direction, and which interlock with the first panels 52. The panels 52, 54 are supported by a base panel 66, and cooperate to define a plurality of cells 58 for receiving parts.

Generally, at least some of the panels 52, 54, 56 may be selected so as to provide improved properties over conventional dunnage trays. In particular, the material used to form the panels 52, 54, 56 may be selected to address one or more of the issues with conventional dunnage trays as discussed above.

In some cases, the material may be a foam board. For instance, in some examples, the panels 52, 54 may be made of a foam board material that is typically used in the manufacturing of headliners for automotive vehicles. Constructing and shaping the headliner for a vehicle, particularly cutting out material for a sunroof, can result in a significant amount of scrap material being created. Currently, there is no commercial use for this scrap material, and many automotive parts suppliers struggle with the cost and environmental impact of disposing of this scrap material, which often ends up in a landfill.

One approach to forming the packaging material as described herein involves recycling headliner material. This could include recovering foam board waste material from a headliner (i.e., from a sunroof cutout), cutting the waste material into one or more specific panel shapes, and then assembling these panel shapes to form a dunnage apparatus having cells for receiving parts therein.

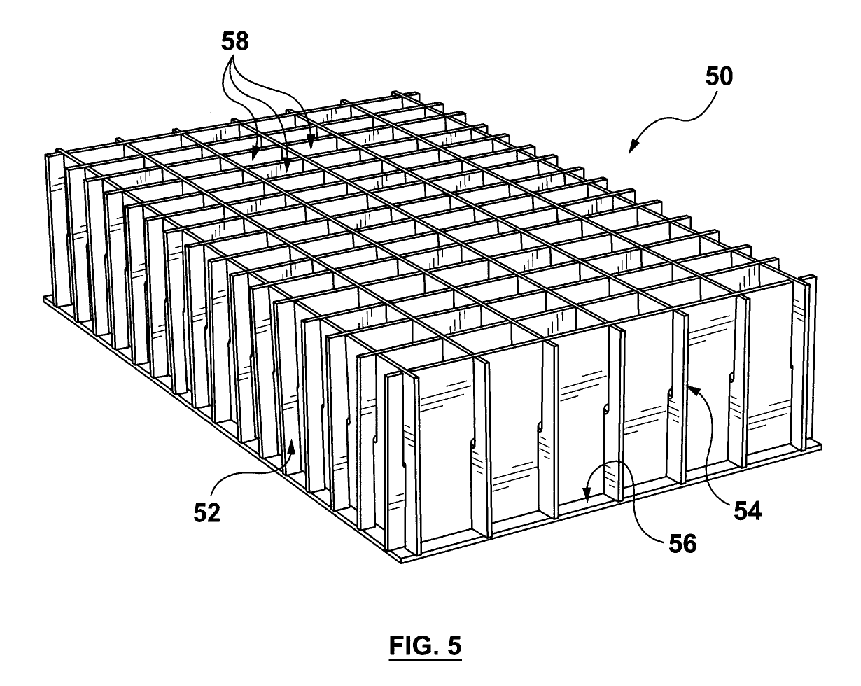

One exemplary foam board (i.e., headliner material) is shown in cross section in FIG. 6. This foam board 60 may be formed by laminating a plurality of layers of different materials together (e.g., layers of different polymers, glass fibers, etc.) so as to form a generally rigid composite structure.

In this example, the first layer 62 is a spunbond layer, such as a layer of polyethylene terephthalate (PET). This may be the “inner” layer of the headliner material 60, which generally faces the occupant and normally has a pleasing aesthetic appearance. The second layer 64 in this example is a barrier film layer, such as a polyethylene (PE) and/or polyamide (PA) film. The barrier film layer 64 may be useful to inhibit moisture from contacting the third layer 66.

The third layer 66 could be a foam layer, such as an open cell or closed cell polymer foam layer. This third layer 66 may be generally rigid, and may provide structural rigidity to the headliner material, as well as acoustic damping and/or other properties. In this example, this third layer 66 includes polypropylene (PP) and/or glass fibers (GF). Finally, the fourth layer 68 may be another film layer, such as a polypropylene (PP) film. All of these layers can generally be bonded together using known techniques, including adhesives, heat, pressure, and so on.

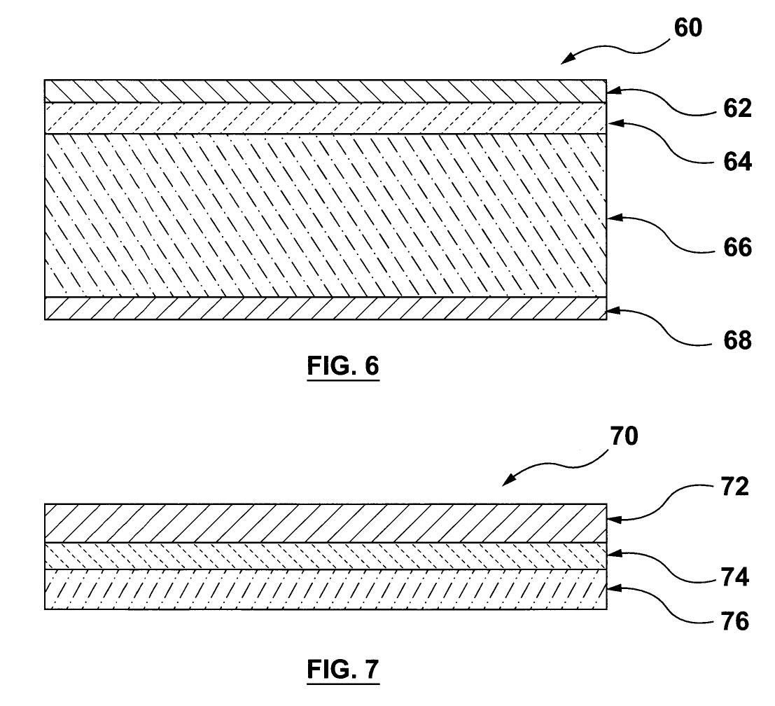

Another exemplary foam board 70 is shown in cross section in FIG. 7. In this example, the first layer 72 is a polyester layer, the second layer 74 is a polyamide (PA) layer, while the third layer 76 is a fabric layer, such as a woven or non-woven fabric layer.

It will of course be appreciated that the foam boards 60, 70 illustrated in FIGS. 6 and 7 are exemplary only, and that not all material used in headliners will necessarily have the same or even similar structures. In other words, headliner composite materials vary greatly from manufacturer to manufacturer. Moreover, manufacturers may change the composition of their headliner materials over time, for example to meet various design goals (i.e., goals related to aesthetic appearance, acoustic performance, cost, etc.). However, it is generally believed that headliner materials of various compositions would be suitable for use as structural panels in a dunnage system.

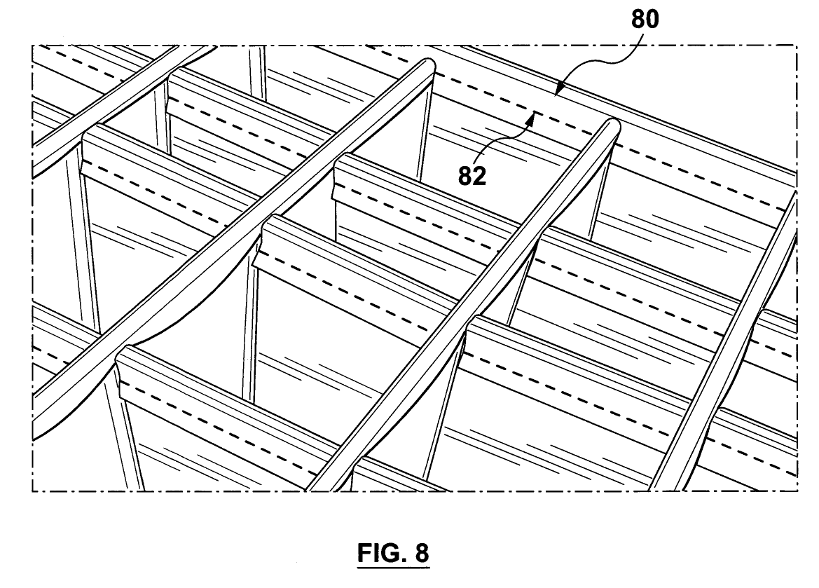

Turning now to FIG. 8, illustrated therein is a packaging apparatus formed using improved structural panels according to some embodiments in which the upper edges of the panels have been covered with a fabric 80. In this example, the fabric 80 is being held in place using stitches 82, although in other cases other fastening techniques could be used, such as the use of an adhesive to secure the fabric 80 to the panels. Generally the use of fabric 80 may act to protect the edges of the panels from delamination as parts are inserted and/or removed from the cells of the packaging apparatus. In particular, the fabric 80 may protect the upper edges of the panels and inhibit the different layers of the structural panels from being separated (i.e., delamination) during use of the packaging apparatus.

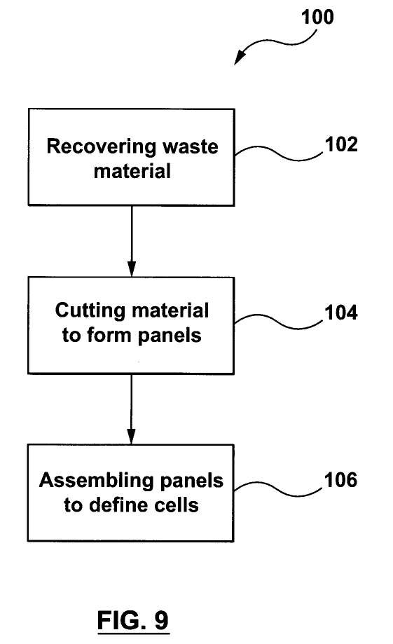

Turning now to FIG. 9, illustrated therein is a method 100 of fabricating a packaging apparatus according to some embodiments.

At step 102, a waste material is recovered, for example foam board waste material that is generated during automotive vehicle manufacturing.

At step 104, the waste material is cut into panels. In some examples, the cutting could be done by die cutting, for example by placing the waste material on a cutting die with a plurality of cutting knives and then passing the waste material through a cutting press, such as a roller press or clicker press. In other examples, cutting could be accomplished using other known techniques.

At step 106, the panels are assembled to form cells for receiving parts therein. For example, panels could be oriented in first and second directions and mounted on a base panel.

### Experimental Data

Several experiments were conducted to investigate the suitability of certain foam board headliner materials for use in packaging apparatus, as compared to conventional dunnage systems. In particular, sample plastic corrugated panels from conventional systems were tested against foam board panels (similar to the panels shown in FIGS. 6 and 7

Specifically, in a first set of experiments, edge crush testing was performed on both materials based on TAPPI 811, along both a machine direction (MD) and cross direction (CD). The edge crush testing was done on a TMI Digital Crush Tester, with samples 2 inches×1 inch in size and a platen speed of 0.5 in/min.

Furthermore, in a second set of experiments, flex testing based on ASTM D642 was performed on both materials (again in both the MD and CD). Flex testing was performed using an Instron Machine, with samples 4 inches×1 inch in size, at a compression speed of 0.5 in/min, and with a 3.75 inch gap from centerline to centerline of the supports for the samples.

The results of these tests are reproduced below in Tables 1-4.

TABLE 1
Edge Crush Corrugated Plastic Samples

| Test | Test | ECT | Deflection |
|---|---|---|---|
| # | Sample | (lb/in) | (in) |
| 1 | Plastic MD | 172.8 | 0.040 |
| 2 | | 185.8 | 0.043 |
| 3 | | 166.8 | 0.058 |
| 4 | | 191.3 | 0.041 |
| 5 | | 185.4 | 0.043 |
| 6 | Plastic CD | 13.8 | 0.132 |
| 7 | | 11.3 | 0.134 |
| 8 | | 19.8 | 0.100 |
| 9 | | 19.6 | 0.034 |
| 10 | | 18.5 | 0.143 |

TABLE 2
Edge Crush Foam Board Samples

| Test | Test | ECT | Deflection |
|---|---|---|---|
| # | Sample | (lb/in) | (in) |
| 1 | Foam MD | 108.4 | 0.084 |
| 2 | | 100.1 | 0.059 |
| 3 | | 111.9 | 0.044 |
| 4 | | 102.5 | 0.058 |
| 5 | | 86.4 | 0.050 |
| 6 | Foam CD | 78.5 | 0.053 |
| 7 | | 77.9 | 0.062 |
| 8 | | 77.0 | 0.043 |
| 9 | | 74.3 | 0.056 |
| 10 | | 49.8 | 0.045 |

TABLE 3
Flex Test Corrugated Plastic Samples

| Test | Test | Force | Deflection at |
|---|---|---|---|
| # | Sample | (lb/in) | Peak(in) |
| 1 | Plastic MD | 1.64436 | 0.40501 |
| 2 | | 1.48914 | 0.37998 |
| 3 | | 1.85863 | 0.45666 |
| 4 | | 1.85495 | 0.44748 |
| 5 | | 1.99493 | 0.41415 |
| 6 | Plastic CD | 7.13662 | 0.50669 |
| 7 | | 7.96436 | 0.54502 |
| 8 | | 7.98350 | 0.53335 |

TABLE 4
Flex Test Foam Board Samples

| Test | Test | Force | Deflection at |
|---|---|---|---|
| # | Sample | (lb/m) | Peak(in) |
| 1 | Foam MD | 2.22964 | 0.40417 |
| 2 | | 2.43337 | 0.49831 |
| 3 | | 2.41834 | 0.48250 |
| 4 | | 2.20529 | 0.39499 |
| 5 | | 2.33511 | 0.42001 |
| 6 | Foam CD | 2.92706 | 0.39085 |
| 7 | | 2.97739 | 0.39336 |
| 8 | | 3.21842 | 0.42250 |
| 9 | | 3.59998 | 0.44503 |
| 10 | | 2.90988 | 0.39083 |

Based on these experiments, the foam board structural panels appear to provide at least some improvement over conventional corrugated plastic structural panels.

In particular, the foam board panels appear to be stronger. For instance, the foam board appears to outperform the corrugated plastic in both “Edge Crush” and “Flex Test”. Specifically, in “Edge Crush” testing, the corrugated plastic (when flutes are oriented 90 degrees to the applied force) deflects much more than foam board panel (*see for example plastic CD deflection of 0.132 inches at 13.8 lbs as compared to foam board deflection MD of 0.084 inches at a higher load of 108.4 lbs). Similarly, in the “Flex Test”, the corrugated plastic panels appear to deflect more than the foam board material.

Note that while MD refers to machine direction, and CD refers to cross direction, the distinction is really only relevant to the anisotropic corrugated plastic material, as the foam board material as tested was generally uniform along each layer direction. Indeed, the foam board material appears to provide more uniform strength than the corrugated plastic. For instance, the data shows that the corrugated plastic panels show different strength characteristics depending on the orientation of the flutes. In contrast, however, the foam board appears to have uniform properties in both CD and MD directions.

The use of foam board (which generally has a laminated structure without flutes) may also facilitate cutting certain shapes, such as rounded corners, beveled corners, curvatures in a cavity formation, and so on as compared to corrugated plastic panels.

The structure of foam board may also reduce tolerance issues, since the shifting problems caused by corrugated material during cutting do not appear to occur.

The use of foam board may also provide one or more further benefits. For example, foam boards may provide improved strength by using composite structures that incorporate multiple bonded layers of alternate fiber types. Since each layer has a generally homogeneous composition (i.e., is not fluted), gaps or weak spots tend to be absent.

Some materials used in foam boards might also help absorb or even eliminate vibration, impact forces, and sound waves.

In some cases, foam boards could incorporate non-woven material and/or layers that might improve adherence to complex geometries and which tend to retain their shape.

In some cases, the materials used in foam boards may provide for increased part surface protection from abrasion and impact, which can be particularly useful for parts with class A surfaces.

Some exemplary foam boards may also have flame retardant properties, may be environmentally friendly, and may not produce off-gases.

In general, foam boards may also be safer to handle (particularly for cutting, shaping, and/or embossing), as they may be less likely to cut or injure an operator.

Foam boards might also provide improved shear strength (i.e., tear strength properties) due to the forces required for layer delamination.

Foam boards may also provide for increased life-cycles prior to structural failures (i.e., joint/bend failures, attachment failure, etc.)

In some cases, the use of foam boards may facilitate alternative shaping techniques, such as laser cutting, which could be used to provide for highly detailed features (although this might increase cycle time as compared to die cutting operations).

In some cases, foam boards might also be moldable to create cavities and/or reduce voids within a tray. This could increase packing density within a tray, which could be quite beneficial.

The use of foam boards may also allow for the formation of cells with better defined shapes, which could be particularly useful for parts with odd or unusual shapes.

The use of foam board may also provide one or more benefits in relation to manufacturing of the panels. For example, cutting foam board may be possible under certain circumstances with a reduced blade height.

Foam boards may also inhibit delamination which can occur with corrugated plastic panels.

In some cases, other processing techniques could be used on foam boards, such as hot knives, water jet, or embossing.

In some cases, foam boards could be used to make totes for carrying bulk items. In some cases, water spray could be applied to the foam board cutting process, for example to reduce dust. In some cases, the foam board could be heated during forming to provide for improved formability (particularly for forming rounded or other curved shapes).

Other benefits may be readily apparent but which have not been fully explored to date. While the above description provides examples of one or more apparatus, methods, or systems, it will be appreciated that other apparatus, methods, or systems may be within the scope of the present description as interpreted by one of skill in the art.

1. A packaging apparatus, comprising:
first panels oriented in a first direction; and
second panels oriented in a second direction and which cooperate with the first panels to define a plurality of cells into which parts can be received;
wherein at least some of the first and second panels are made from reclaimed waste material.

2. The packaging apparatus of claim 1, further comprising a base panel for supporting the first and second panels.

3. The packaging apparatus of claim 2, wherein the base panel is made from reclaimed waste material.

4. The packaging apparatus of any preceding claim, wherein the first direction is perpendicular to the second direction.

5. The packaging apparatus of any preceding claim, wherein the first and second panels interlock to define the cells.

6. The packaging apparatus of any preceding claim, wherein the waste material comprises a foam board.

7. The packaging apparatus of any preceding claim wherein the waste material is used in the manufacturing of headliners for automotive vehicles.

8. The packaging apparatus of any preceding claim wherein the waste material is a rigid composite.

9. The packaging apparatus of claim 8 wherein the rigid composite is formed by laminating a plurality of layers of different materials together.

10. The packaging apparatus of claim 9, wherein at least one of the materials is a polymer layer.

11. The packaging apparatus of claim 9 or claim 10, wherein at least one of the layers includes glass fibers.

12. The packaging apparatus of any one of claims 9 to 11 wherein the plurality of layers includes a first spunbond layer.

13. The packaging apparatus of claim 12, wherein the spunbond layer is a layer of polyethylene terephthalate (PET).

14. The packaging apparatus of any one of claims 9 to 13 wherein the plurality of layers includes a second barrier film layer.

15. The packaging apparatus of claim 14 wherein the barrier film layer is selected so as to inhibit moisture from contacting another layer of the plurality of layers.

16. The packaging apparatus of claim 14 or 15 wherein the barrier film layer is a polyethylene (PE) film.

17. The packaging apparatus of claim 14 or 15 wherein the barrier film layer is a polyamide (PA) film.

18. The packaging apparatus of any one of claims 9 to 13 wherein the plurality of layers includes a third foam layer.

19. The packaging apparatus of claim 18 wherein the foam layer comprises an open cell polymer foam layer.

20. The packaging apparatus of claim 18 wherein the foam layer comprises a closed cell polymer foam layer.

21. The packaging apparatus of claim 18 wherein the foam layer is rigid.

22. The packaging apparatus of any one of claims 18 to 21 wherein the foam layer comprises polypropylene (PP).

23. The packaging apparatus of any one of claims 18 to 21 wherein the foam layer comprises glass fibers (GF).

24. The packaging apparatus of any one of claims 9 to 23 wherein the foam layer comprises a fourth film layer 68.

25. The packaging apparatus of claim 24 wherein fourth film layer comprises a polypropylene (PP) film.

26. The packaging apparatus of claim 9, wherein the plurality of layers comprises a first polyester layer, a second polyamide layer, and a third fabric layer.

27. A packaging apparatus, comprising:
first panels oriented in a first direction;
second panels oriented in a second direction and which interlock with the first panels to define a plurality of cells into which parts can be received; and
a base panel for supporting the first and second panels;
wherein at least some of the first and second panels comprise a rigid composite having a plurality of layers, including a foam layer and a fabric layer.

28. The packaging apparatus of claim 27, wherein the rigid composite is reclaimed waste material.

29. A method of fabricating a packaging apparatus, comprising:
recovering waste material;
cutting the waste material into one or more panels; and
assembling the panels to form cells for receiving parts therein.

30. The method of claim 29, wherein the waste material is a rigid composite.

31. The method of claim 29 or claim 30 wherein the waste material is from a headliner used in automotive vehicles.

32. The method of any one of claims 29 to 31 wherein the waste material comprises a foam board.

33. The method of any one of claims 29 to 32 wherein the waste material is cut into panels by die cutting.

34. The method of claim 33 wherein the die cutting is done using a roller press.

35. The method of claim 33 wherein the die cutting is done using a clicker press.
